(19) United States
(12) Patent Application Publication
(10) Pub. No.: US 2013/0043178 A1
(43) Pub. Date: Feb. 21, 2013

(54) DEVICE FOR FILTERING AND SEPARATING FLOWING MEDIA

(71) Applicant: Udo ARBEITER, Seevetal (DE)

(72) Inventor: Udo ARBEITER, Seevetal (DE)

(21) Appl. No.: 13/233,061

(22) Filed: Sep. 15, 2011

(30) Foreign Application Priority Data
Aug. 15, 2011 (EP) 11 006 673.5

(51) Int. Cl. B01D 63/00; B01D 63/02

(52) U.S. Cl. 210/321.78; 210/321.72

(57) ABSTRACT

A device for filtering and separating flowing media by means of membranes, in particular by the method of ultrafiltration, reverse osmosis and nanofiltration includes a housing in which the membranes are disposed, an inlet for the flowing medium that is carried in the device and is to be separated, and one outlet for carrying out the permeate produced in the device and one outlet for the retentate leaving the device, which substantially forms a separation unit. The device furthermore includes a container in which at least two separation units are received, connected to one another in such a way that for the delivery of the flowing medium to be separated to the at least two separation units, a common inlet is provided.

### BACKGROUND OF THE INVENTION

1. Field of the Invention

The invention relates to a device for filtering and separating flowing media by means of membranes, in particular by the method of ultrafiltration, reverse osmosis and nanofiltration, using a housing in which the membranes are disposed, an inlet for the flowing medium carried in the device that is to be separated, and one outlet for carrying out the permeate produced in the device and one outlet for the retentate, the device substantially forming a separation unit.

2. Related Art

Devices of this type are known in the prior art in the many manifold embodiments and are used for various tasks of separating various fluid mixtures in industry, on ships, on exploration platforms in the sea, on warships, in the automotive industry, in aircraft construction, and in private applications, whenever the fluid mixtures have to be broken down into their component parts. For instance, devices of the type defined at the outset above are used not only in stationary applications but also on moving units such as ships and the like, for instance, if seawater is to be desalinated in order to obtain fresh water for drinking or for other uses. However, such devices are also used in stationary applications, such as for water that seeps from garbage dumps, for separating out harmful mixture components in such a way that the pure water produced can be released into the environment without concern.

One very broad field of use of such devices is separating gaseous fluid mixtures, and one important application is in petrochemistry, for instance for separating out inert gases contained in natural gas, or in the case of the gaseous mixture of air and gaseous hydrocarbons such as gasoline and the like, for separating out the gasoline in liquefied form; in large gasoline storage systems or tanks, such mixtures occurring for instance above the surface of the liquid gasoline, where the goal is to recover the gasoline portion again by membrane separation.

The membranes used for this are as a rule polymer membranes, which are widely known in industry, and for the special separation task desired, various suitable membranes are available that are capable of performing the desired separation task.

Typically, regardless of the type of medium or fluid mixture to be separated, devices of the type mentioned at the outset are installed in successive and/or parallel arrangements, to make a sufficiently large membrane surface area available for the particular separation task desired. In the field, the term “separation modules” is often used as well, and they have to be assembled with a view to the desired separation task. This entails a great deal of planning and engineering work, since every device or separation module has to be connected to another separation module by means of labor-intensive pipe installations, not only for the medium or, in other words, for the fluid mixture to be separated, but also for both the permeate leaving the many assembled and joined-together devices and the retentate leaving these same devices.

In ultrafiltration, the permeate is also called the filtrate.

These pipe connections must meet extremely stringent demands for tightness, since they must be absolutely leakproof under all possible pressure and temperature conditions that can occur and are to be expected in the use of such devices, so that mixing of the three componentes, such as the supplied medium that is to be separated and the permeate and the retentate, is avoided. If even only two of the components become mixed, the device or the many interconnecteed devices become unusable and have to be tediously disassembled, cleaned, re-sealed, and put back together again. This requires a very great amount of time, which is expressed directly in the costs entailed, not to mention the unacceptable degree of unreliability of such arrangements of devices.

### SUMMARY OF THE DISCLOSURE

It is therefore the object of the present invention to furnish a device of the type defined at the outset, in which a plurality of devices can be joined together in such a way that the effort of joining these devices can be reduced to a minimum and the operating safety of such devices can be enhanced significantly compared to the known devices, with the further goal of minimizing the production costs for such arrangements of devices as well as the space required for them, so that with greater overall operating safety, the procurement and maintenance costs can be reduced considerably as well, which is meant to apply to the assembly and disassembly costs as well.

This object is attained according to the invention in that a container is provided in which at least two separation units are received, connected to one another in such a way that a common inlet is provided for delivering the flowing medium that is to be separated to the at least two separation units.

The advantage of the provisions of the invention is that at least two separation units can be coupled to one another without the expense of installation of pipes, and without requiring separate pipe connections for delivering the medium, that is, the fluid, also known in this field as “feed”. The two separation units are merely placed in the container and are coupled to one another by the connection means already installed beforehand in the container. This installation ensures that a continous pressure-tight connection from the inlet for the medium to be separated to the two separation units can be achieved. At least in the case of two separation units, no further installation effort is necessary, and as a consequence, the possibility that leaks will occur is drastically reduced. Moreover, compared with the known devices, a considerable reduction in weight of the overall device is also achieved. The provisions according to the invention, because of the greatly reduced external dimensions and weight, make applications of the device possible that were impossible until now, for instance on moving units and also in maritime platforms, where avoiding any additional weight is crucial, and this applies equally to the spatial volume required for the device. In turn, without major installation effort and expense, the device of the invention itself can be connected in modular fashion to a plurality of devices of the invention to make large desired separation units to suit the total membrane surface area desired.

The provisions according to the invention attain all the aspects of the object as it is stated above.

As noted at the outset, the membranes and membrane elements used for the special separation task are employed for such tasks of separating and filtering flowing media and fluids. What is crucial is not only the embodiment of the membrane, in terms of the membrane material to be used, which as a rule comprises hydrocarbon-based polymers, but also the type of membranes, in terms of their mechanical structure. It has for instance proved advantageous for the device according to the invention for the membranes to be embodied as hollow-filament and/or capillary membranes, although in principle flat membranes can also be used, for instance in the form of membrane cushions or spirally wound coil membranes.

Advantageously, the container is embodied such that the separation units are disposed one after the other substantially on a container axis. It is thus attained that the delivery to the two separation units of the medium that is to be separated is necessary over a minimal line connection to the separation units for the medium or fluid to be separated.

It is especially advantageous if the inlet for the flowing medium to be separated is disposed on the container in such a way that from the container, the flowing medium can be conducted into both the one and the other separation unit simultaneously, more or less by introducing the medium to be separated via an approximately T-shaped connection in the separation unit.

The container itself can be embodied as substantially tubular, although in principle other designs are also possible, for instance such that the two separation units are in fact disposed side by side. The substantially tubular embodiment of the container, however, makes fast, safe and secure installation of the separation units in the container itself possible, and the separation units stabilize automatically in the container, so that no complicated fastening and aligning means inside the container are needed for the separation units. As a result, the procurement, repair and maintenance costs can be reduced still further.

In another advantageous embodiment of the device, the container has a substantially circular cross section; that is, it is advantageously embodied as a substantially linear tube, so that the separation units to be placed in the container, which are in fact connected one after the other in a row, are automatically stabilized and aligned. “One after the other” does not mean that the separation units are, or always have to be, connected successively in terms of their separation function, but only that they are disposed mechanically in such a way that they are located approximately one after the other in a row.

In still another advantageous embodiment of the device, one inlet for the flowing medium to be separated is provided on each of substantially opposite locations of the container; that is, preferably, if the container is embodied as tubular, for instance, the locations of the inlets is positioned substantially centrally relative to the longitudinal extent of the container, so that by means of the dual inlets, the total inlet cross section for the medium to be separated can easily be increased inward into the inside of the container, so that the flow of the flowing medium through the container can easily be increased to enable adapting it to the particular higher separation capacity desired.

The outlets for the permeate are advantageously embodied on substantially opposite ends of the container, so that the requisite installation for removal of the permeate can be kept small, and the overall container can also be inserted, on the order of a battery of a plurality of containers, into a correspondingly large separation unit. The outlets themselves are inserted, provided with suitable sealing means, into receptactles which can also have sealing means, without requiring additional installations.

Advantageously, the outlets for the retentate are embodied in the vicinity of substantially opposite sides, substantially crosswise to the container housing, and which can also have sealing means and which are likewise disposed in a large separation unit. The outlets can be inserted in a direction substantially crosswise to the container housing, without requiring further installation means for collecting the retentate emerging from the container.

With a view to the disadvantages of devices known from the prior art, which include, among other disadvantages, considerable weight, the goal sought with the invention is to reduce the total weight, which is advantageously attained if the container is embodied of plastic, and it is especially advantageous, for further reducing the weight of the plastic required for this, to reinforce the plastic with carbon fibers or glass fibers. The plastic for embodying the container also has the advantage that the container is substantially largely corrosion-resistent with regard to the medium, or fluid mixture, so called because it is liquid or gaseous, that is to be separated, and the container is also sufficiently dimensionally stable in the temperature range to be expected and is low in weight.

Since the separation units that are received in the container are each received by a housing which has to be sufficiently pressure-stable, the housing and/or the closure elements of the separation unit on both sides are of metal, which also ensures the dimensional stability of the separation unit itself sufficiently to continuously ensure deformation of the membrane elements received in the housing of the separation unit, and at last the housing, often also called a pressure tube, can comprise plastic or glass-fiber-reinforced plastic. The closure elements on both sides, also called end plates, are typically of aluminum. Since steel is known to have very good strength properties, until now both the housing of the separation units and the closure elements provided there on both sides have in fact as a rule been made of steel. However, since the specific weight of steel is considerable, which in principle and in certain cases runs counter to the goal stated at the outset, it is advantageous according to the invention, for forming a device that is lighter in weight than the known devices, to make at least the closure elements on both sides of titanium.

To make it possible, quickly and substantially without tools, to insert the separation units into and remove them the container housing for assembly and disassembly or for repair and maintenance, the container housing can advantageously be divided into at least two container housing elements, which in turn can be joined to one another via connecting means, and these connecting means can intrinsically be of any suitabl type, for instance in the form of tight-fit or plug-in connections. However, it is very particularly advantageous to embody the connecting means on the container housing elements by means of threaded areas and/or bayonet mounts. Threaded connections are self-centering and self-locking, which is also true of bayonet mounts, so that no additional means are required for securing the two housing elements, and as a result, in accordance with the stated object, the weight can be lowered, and assembly and disassembly tasks can be reduced to a minimum.

### BRIEF DESCRIPTION OF THE DRAWINGS

The invention will now be described in detail in conjunction with the following schematic drawings, in terms of an exemplary embodiment and a modification of the exemplary embodiment. In the drawings:

FIG. 1, in a perspective view, shows the device according to the invention, including a container, comprising two container housing elements, for receiving two separation units;

FIG. 2, partly in section and in side view and omitting some details, shows a separation unit which is equipped with membranes in the form of hollow-filament membranes and/or capillary membranes;

FIG. 3, partly in section and in a fragmentary detail, shows the container shown in FIG. 1 for receiving two separation units;

FIG. 4 is a view of the face end of the container of FIG. 3;

FIGS. 5a and 5b, in side view, each show FIG. 3 rotated 90°;

FIG. 5c is a view of the face end of FIGS. 5a and 5b; and

FIGS. 6a through 6c show a view analogous to FIGS. 5a through 5c, but with two inlets for the flowing medium to be separated.

### DETAILED DESCRIPTION OF PREFERRED EMBODIMENTS OF THE INVENTION

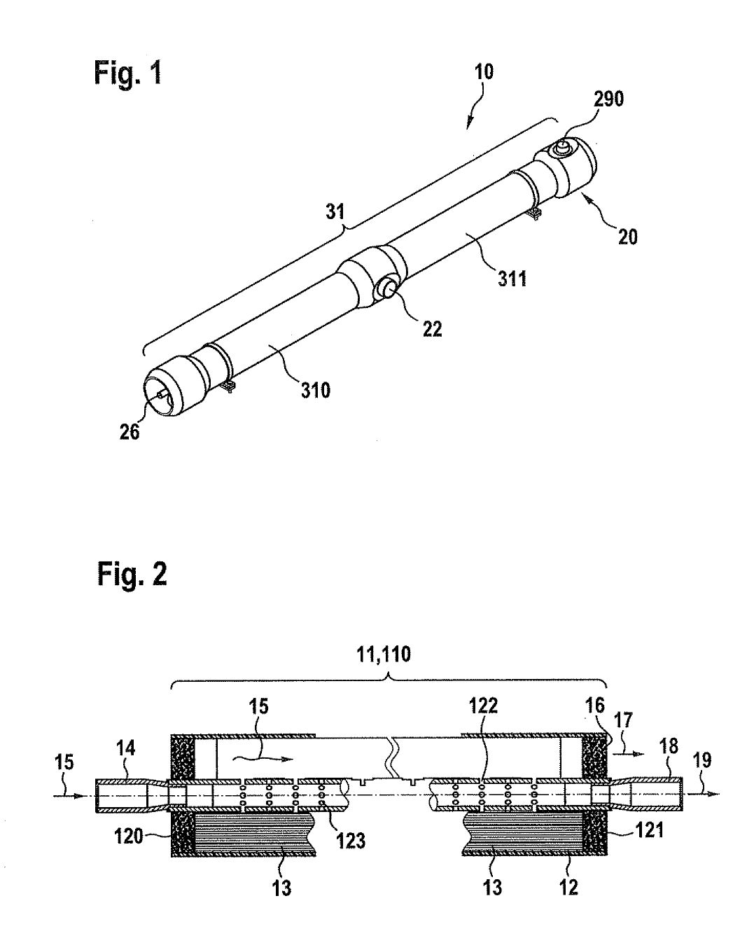

First, FIGS. 1 and 2 will be referred to, in order to describe the fundamental construction of the device 10.

In FIG. 1, the container 20 of the device 10 is shown in perspective, and the container housing 31 is divided into two container housing elements 310, 311. One separation unit 11, 110 is received in each of the container housing elements 310, 311, and as a rule the separation units 11, 110 are identical in structure, although versions of the device 10 are conceivable in which the separation units 11, 110 have a different construction and each have different separation specifications with regard to the flowing medium 21, often also called fluid or “feed”, that is delivered jointly into one inlet 22 for both separation units 11, 110.

The basic construction of a separation unit 11, 110 of the kind shown as an example in FIG. 2 is well known. The separation unit 11, 110 shown in FIG. 2 is equipped with membranes 13 in the form of hollow-filament and/or capillary membranes. In principle, however, separation units 11, 110 which are to be received in the container 20 can be used with membranes in the form of cushion membranes or spirally wound coil membranes. Fundamentally, the separation unit 11, 110 has a housing 12 which is capable of withstanding the pressures of the flowing medium 15 inside the housing and is as a rule made of plastic or fiber-reinforced plastic, but it can also be made of steel, in the form of a steel tube. On both ends of the housing, closure elements 120, 121 are provided in a manner known per se, and the hollow-filament or capillary membranes 13 are spread out between them; see FIG. 2. Together with the housing 12, the closure elements 12, 121, kept suitably spaced apart from one another, form a pressure-tight chamber in which the flowing medium 15 to be separated flows. As a rule, in such separation units 11, 110 the housing 12 has a central tube 122, which has holes 123 distributed over the circumference that penetrate the wall of the tube 122. The permeate 17 is collected in this central tube 122 and carried away.

If the membranes are embodied as hollow-filament membranes, the flowing medium 15 flows through the hollow filaments, and from the hollow space, the permeate 17 passes through the walls of the hollow-filament membrane from the inside outward.

Via an inlet 14, which is disposed outside the closure element 120 and which is joined to the tube 122, the flowing medium 15 to be separated is introduced into the tube 122, and through the holes 123 it passes into the interior of the housing 12, in which the membranes 13 are disposed. The flowing medium 15 passes in a known manner through the walls of the membranes, or of the mixture component in the flowing medium 15 for which the membranes 13 are selective. Inside the membranes 13, that is, in the hollow space in the hollow-space membranes, or the capillary membranes with regard to the example described here, the permeate 17 that has accumulated in them is collected at one or optionally both ends of the housing 12 (not shown in detail here) and is carried away to the outside as permeate 17 via an outlet 16.

The now-concentrated flowing medium 15 leaving the separation device 11 via the outlet 18 in the extension of the tube 122; in other words, the remaining flowing medium 15, which has been reduced by the component that has permeated through the membranes, is carried out of the housing 12 as retentate 19 in the extension of the tube 22.

It should be noted that the schematic construction described above of such separation units 11 are well known in the industry in this and similar forms, so that there is no need to describe the construction of the separation unit 11 further here. However, it should be mentioned that in the device 10 shown here, both to reduce the weight and for the sake of mechanical stability and chemical stability with regard to the flowing medium 15, the closure elements 120, 121 on both sides and/or the housing 12, instead of being made of steel, can be made of aluminum or titanium, which with greater strength than high-alloy steel has a very much lower weight.

The separation unit 11 described can be operated in intrinsically the same manner as described above, depending on the various types of membranes (hollow-filament membranes, capillary membranes, coil membranes, membrane cushions). Depending on the various types of membrane used, not only the delivery of the flowing medium 15 to be separated but also the removal of both the permeate 17 and the retentate 19 can be done in a modified manner, although this changes nothing in the above-described principle of separation of the flowing medium 15 to be separated.

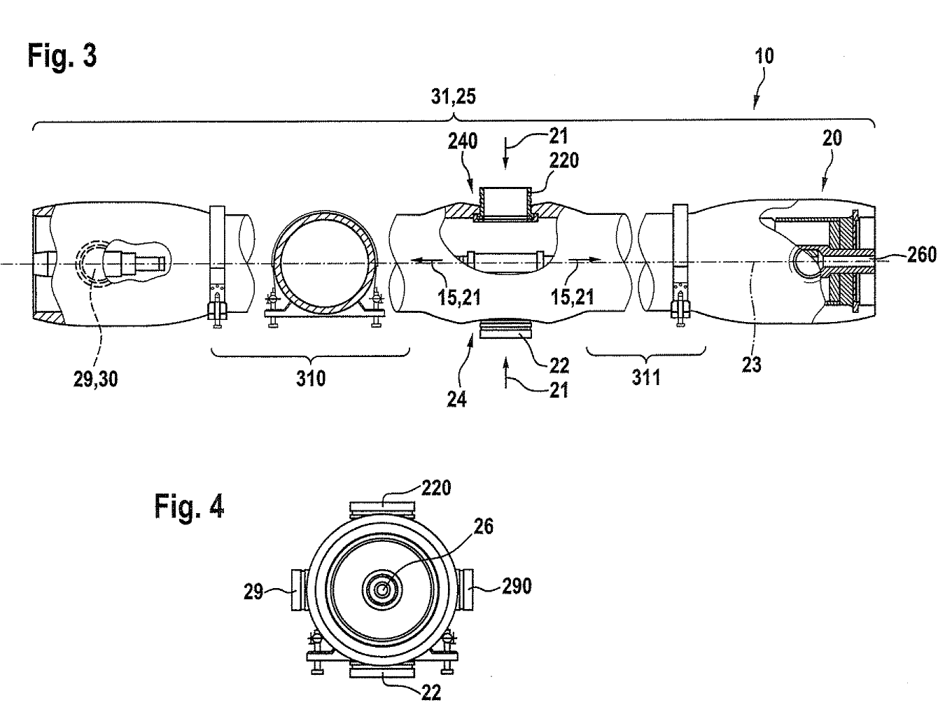

In FIG. 3, the container 20 for receiving two separation units 11, 110 is shown. The container 20 substantially comprises a tubular body with a substantially circular inside cross section, so that the separation units 11, 110 can be received in it in guided fashion, since the cross section of the separation units 11, 110 is substantially equivalent to the inside cross section of the container 20. With regard to the longitudinal extent 25 of the container, the actual container housing 31, as already mentioned in conjunction with the description of FIG. 1, the container 20 includes container housing elements 310, 311 of substantially equal size, and substantially centrally between the two container housing elements 310, 311, at least one inlet 22 for the flowing medium 21 is provided; the flowing medium 21 is the same as the flowing medium 15 that has been described above in conjunction with the description of the separation unit 11.

Once the two separation units 11 are positioned inside the container 20, the flowing medium 21 flows via the inlet 22 into the inlet 14 of the respective separation units 11, 110. This is represented symbolically by the arrows 15, 21 on both sides of the inlet 22 in FIG. 3. The connection between the inlet 22 of the container 20 and the respective separation units 11, 110 is ensured both by a suitable structural embodiment of both the inlet 14 of the separation units 11, 110 and by the suitable structural embodiment of the inlet 22 inside the container 20, so that a mechanically secure connection and a pressure-tight connection between the inlet 22 and the inlet 14 is ensured.

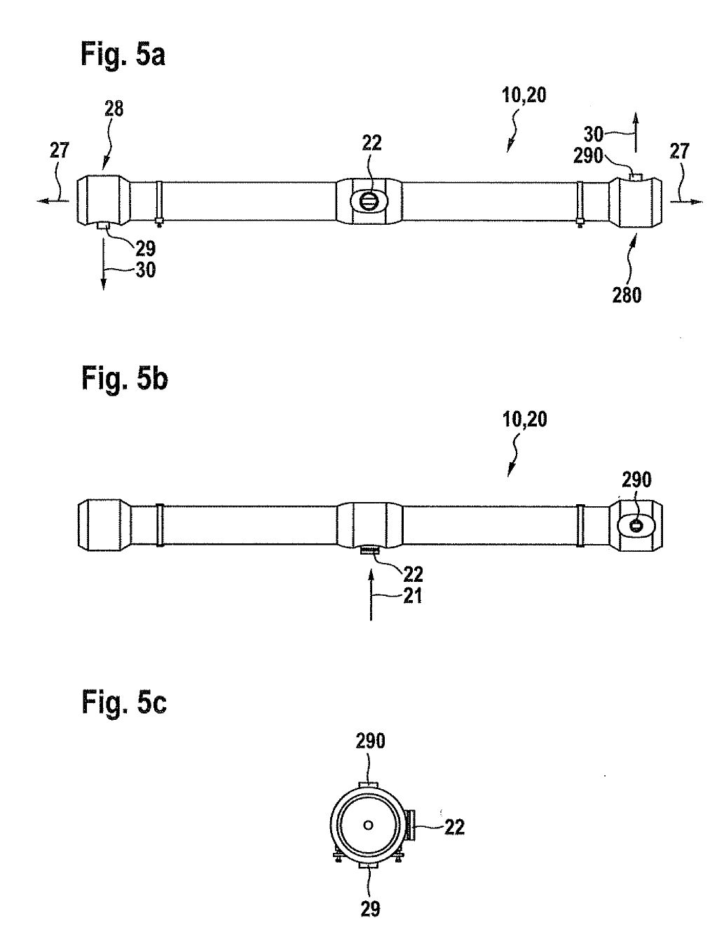

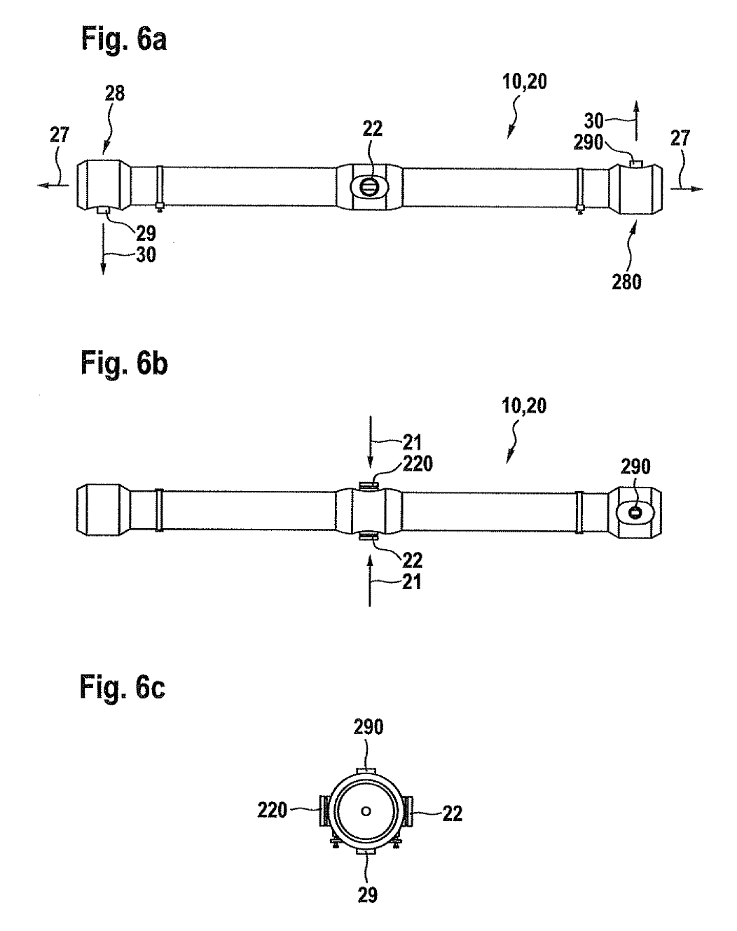

On both ends 28, 280 of the container 20—see particularly FIGS. 5a through 6c—respective outlets 26, 260 for the permeate 27 leaving the device 10, or in other words the container 20, provide that the permeate is either subjected to some other treatment, optionally to another separation, or is carried away and collected. As a rule, the outlets 26, 260 are disposed concentrically to the container axis 23 that passes through the container 20.

Also in the vicinity of the ends 28, 280 of the container 20 or container housing 31, respective outlets 29, 290 for the retentate 30 leaving the device 10 are provided, emerging substantially radially from the container housing. The retentate 30 is either delivered back to the separation system again or collected otherwise and delivered to some other use.

The device 10 shown in FIGS. 5a through 5c includes one outlet 29, 290 on each of its two ends 28, 280 of the container 20 for the retentate 30, as described above, and this applies equally to the devices in FIGS. 6a through 6c. One outlet, 29 or 290, in a different mode of operation of the device 10, can also serve as a vent for the housing 22 of the separation unit 11 or separation units 11, 110 and/or as a vent for the container 20 or container housing.

In a “dead-end” mode of operation of the device 10, the outlets 29, 290 are closed. In another mode of operation, known as the “cross-flow mode”, the outlets 29, 290 are opened for removal of the retentate 30.

In the embodiment of the device 10 shown in FIGS. 6a through 6c, however, compared to the embodiment of the device 10 shown in FIGS. 5a through 5c, one inlet 22, 220 each for the flowing medium 21 is provided at the location 24, 240, respectively, diametrically opposite the container axis 23 in the radial direction. This embodiment of the device 10 is also shown in FIG. 3 and in FIG. 4. As a result, compared to the embodiment of the device 10 with only one inlet 22 for the flowing medium 21, a higher throughput of the flowing medium 21 through the device 10 per unit of time and an improved parallel distribution of the delivered flowing medium 21 to be separated to the two or more separation units 11, 110 are possible.

As already mentioned, the container 20 includes at least two container housing elements 310, 311, which can be connected (not shown) at the middle portion of the container housing 31 via respective threaded connections and/or bayonet mounts. Such detachable or separable connections allow easy disassembly and assembly of the container housing 31, for instance to have fast access to the separation units 11, 110 received in it, in other words for repair and maintenance purposes, but also for the basic initial assembly process. The container housing 21 substantially comprises plastic, specifically carbon-fiber- or glass-fiber-reinforced plastic, the first of which has the advantage of great strength with low weight.

All the outlets 25, 260 for the permeate 27 and all the outlets 29, 290 for the retentate 30, like the inlets 22, 220 for the flowing medium 21 to be separated, are designed structurally in such a way that they make a fast, pressure-tight connection to further devices 20 possible, for instance if a plurality of devices are to be connected to one another either in parallel or in a row or partly parallel and partly in a row, in a separation unit or separation battery not shown here.

### LIST OF REFERENCE NUMERALS

10 Device
11 Separation unit
110 Separation unit
12 Housing
12 Closure element
121 Closure element
122 Tube
13 Membrane(s)
14 Inlet/flow medium (housing)
15 Flow medium (housing)
16 Outlet/permeate (housing)
17 Permeate (housing)
18 Outlet/retentate (housing)
19 Retentate (housing)
20 Container
21 Flow medium (container)
22 Inlet/flow medium (container)
220 Inlet/flow medium (container)
23 Container axis
24 Location
240 Location
25 Longitudinal extent (container)
26 Outlet/permeate (container)
260 Outlet/permeate (container)
27 Permeate (container)
28 End (container)
280 End (container)
29 Outlet/retentate (container)
290 Outlet/retentate (container
30 Retentate (container)
31 Container housing
310 Container housing element
311 Container housing element

1. A device for filtering and separating flowing media by membranes, comprising a separation unit comprising a housing in which membranes are disposed, an inlet for the housing for a flowing medium circulated in the device and which is to be filtered, and one outlet for the housing for carrying out permeate produced in the device and one outlet for the housing for retentate, a container in which at least of said two separation units are received, said separation units being connected to one another in such a way that, for the delivery of a flowing medium to be separated to the at least two separation units, a common inlet is provided.

2. The device as defined by claim 1, wherein the membranes are hollow-filament membranes and/or capillary membranes.

3. The device as defined by claim 1, wherein the container is configured such that the separation units are disposed one after the other substantially along a container axis.

4. The device as defined by claim 1, wherein the common inlet for the flowing medium to be separated is disposed on the container in such a way that from the container, the flowing medium is carried simultaneously into both separation units.

5. The device as defined by claim 1, wherein the container is substantially tubular.

6. The device as defined by claim 1, wherein the container has a substantially circular cross section.

7. The device as defined by claim 1, wherein the container is configured as a substantially linear tube.

8. The device as defined by claim 1, wherein one inlet each for the flowing medium to be separated is connected upstream of substantially opposite locations of the container.

9. The device as defined by claim 8, wherein the locations of the inlets are positioned substantially centrally, relative to a longitudinal length of the container.

10. The device as defined by claim 1, wherein the container has opposite ends and outlets for the permeate are disposed at substantially the opposite ends of the container.

11. The device as defined by claim 1, wherein the container has opposite ends and outlets for the retentate are disposed substantially in the vicinity of the opposite ends of the container and extend substantially transversely to the container.

12. The device as defined by claim 1, wherein the container comprises plastic.

13. The device as defined by claim 12, wherein the plastic comprises carbon-fiber- and/or glass-fiber-reinforced plastic.

14. The device as defined by claim 1, wherein the separation unit has opposed ends, and the housing and/or closure elements on both ends of the separation unit comprise metal.

15. The device as defined by claim 14, wherein at least the closure elements on both ends of the separation unit comprise titanium.

16. The device as defined by claim 1, wherein the container housing is divisible into at least two container housing elements, which are connected to one another via a connection arrangement.

17. The device as defined by claim 16, wherein the connecting arrangement comprises threaded regions or bayonet mounts provided on the container housing elements.

18. The device as defined by claim 1, wherein inlets for the flowing medium and/or outlets for the permeate and/or outlets for the retentate comprise metal.

19. The device as defined by claim 18, wherein the metal is steel.

20. The device as defined by claim 18, wherein the metal is titanium.
